(19) United States
(12) Patent Application Publication
(10) Pub. No.: US 2008/0256054 A1
(43) Pub. Date: Oct. 16, 2008

(54) Computer-implemented method and system for targeting contents according to user preferences

(75) Inventor: John Marshall Saaty, McLean, VA (US)

Correspondence Address: POSZ LAW GROUP, PLC, 12040 SOUTH LAKES DRIVE, SUITE 101, RESTON, VA, 20191, US

(73) Assignee: Decision Lens, Inc., Arlington, VA (US)

(21) Appl. No.: 11/783,436

(22) Filed: Apr. 10, 2007

(51) Int. Cl. G06F 17/30

(52) U.S. Cl. 707/5; 707/E17.014

(57) ABSTRACT

A method, system, and device targets contents according to the preferences of a particular user. A content is associated with one or more content category alternatives, and is different from other contents. Pairwise comparisons for a particular user for a set of content category alternatives are input into a computer, wherein a pairwise comparison includes a judgment between preferences as a relative importance between two content category alternatives. A weighted prioritization of the content category alternatives of the pairwise comparisons for the particular user is prepared in the computer, according to an analytic hierarchy process. The weighted prioritization of the content category alternatives for the particular user is applied, in the computer, to the contents. A weight is associated with the content according to the weighted prioritizations of the content category alternative corresponding to the content categorization of the contents. The contents are provided according to the weight.

### BACKGROUND OF THE INVENTION

1. Field of the Invention

The present invention relates in general to computerized analyses for assessing consumer content preferences.

2. Description of the Related Art

Current content management systems for online content approach how they present the content to the user in one of two ways. First, they can simply present “one-size-fits-all” content to the users. This type of content management system treats every user exactly the same, but in certain areas content might be prioritized based on the number of clicks for that particular content. An example of this is seen at many news story web sites, such as cnn.com.

A second type of content management system asks the user to set up their own page by giving them numerous choices, so that the user is responsible for all of the content customization. Often the user is overwhelmed and might not design the site according to their preferences, but rather according to the choices which are presented and the manner in which the choices are presented. An example of this type of site can be seen on the “my yahoo” web site (my.yahoo.com).

### BRIEF DESCRIPTION OF THE SEVERAL VIEWS OF THE DRAWING(S)

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a user interface illustrating an interaction with a user to obtain pairwise comparisons for a set of content category alternatives.

FIG. 2 is a diagram illustrating an exemplary judgment matrix, in accordance with one or more embodiments.

FIG. 3 illustrates a weighted prioritization for content category alternatives.

FIG. 4 is a user interface illustrating a sample layout of content.

FIG. 5 is a block diagram illustrating portions of an exemplary computer, in accordance with various embodiments.

FIG. 6 illustrates a user interface illustrating an interaction with the user to change priority.

FIG. 7 is an example user interface illustrating a product or service recommendation.

FIG. 8 is a flow chart illustrating an exemplary procedure for targeting contents for preferences of a user, in accordance with various exemplary and alternative exemplary embodiments.

FIG. 9 is a flow chart illustrating an exemplary procedure for rating content for a user.

FIG. 10 is a flow chart illustrating an exemplary procedure for rating content based on similar weighted prioritizations.

### DETAILED DESCRIPTION

In overview, the present disclosure concerns computers, computer networks and computer systems, such as an intranet, local area network, distributed network, or the like having a capability of analyzing variables in decision models. Such computer networks and computer systems may further provide services such as interacting with users, and/or evaluating modifications to a decision model. More particularly, various inventive concepts and principles are embodied in systems, devices, and methods therein related to targeting contents according to preferences of a particular user utilizing a decision model, such as an analytic hierarchy process. It should be noted that the term device may be used interchangeably herein with computer, wireless communication unit, or the like. Examples of such devices include personal computers, general purpose computers, personal digital assistants, cellular handsets, and equivalents thereof.

The following detailed description includes many specific details. The inclusion of such details is for the purpose of illustration only and should not be understood to limit the invention. Throughout this discussion, similar elements are referred to by similar numbers in the various figures for ease of reference. In addition, features in one embodiment may be combined with features in other embodiments of the invention.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein below, various inventive principles and combinations thereof are advantageously employed to target contents to a user according to the user's preferences. Implicit user preferences for online content and recommendations are made explicit through a pairwise comparison process of a set of content category alternatives, through a computer keyboard, mobile device, or the like. The user's preference structure can be captured through an Analytic Hierarchy Process (AHP). A weighted prioritization of the content category alternatives can be developed. Optionally, the consistency of judgments for the set of content category alternatives can be checked according to Analytic Hierarchy Process (AHP) methodology to ensure that the user has provided a valid profile set. Once the priorities are captured for that particular user, the priorities can be applied, for example to a display of content or provision of recommendations for that specific user. In a content management system, for example, the weights can be used to determine for that specific user, in what areas and how much content is to be displayed across a series of parameters including ordering of content, size of content, and placement of content through the graphical user interface or display. The display of content or recommendations can differ from user to user, depending on each user's expression of preferences as captured through the pairwise comparison process.

Optionally, the user can change their preferences “on the fly.” They can be presented with a bar-chart sensitivity graph showing their stated preferences. By clicking and dragging any bar, the user can increase or decrease the preference for the content category alternative, with the user's preferences being recalculated and the provision of the contents being adjusted based on the newly stated preferences.

Content publishers, advertisers, and others then may provide contents such as advertising, articles, and recommendations according to the preferences profiles communicated by the users. For example, on a news site the user can be asked if they prefer “Latest News” stories to “Travel” stories, “Travel” stories to “Technology” stories, and so on. Then, the user's preferences for each of the content category alternatives can be applied, for example in a content serving platform, ad serving platform, or recommendation serving platform, so that the articles, recommendations, advertisements, and the like which are presented can be more relevant to the user. For example, a user who has indicated that “travel” was their top area of interest can be presented with online travel advertisements to take advantage of their communicated area of interest.

Due to the targeting, expected response to the contents should be higher, and thus it is expected that revenue will increase. The disclosed method, system and device can be more effective than conventional “behavioral targeting” techniques which attempt to deduce what the user might like based on web sites that the user visited, together with nominal geographic and/or demographic user-specific information.

Targeting can be performed using a decision model such as an analytic network process (“ANP”), or more particularly an AHP decision feedback network. An ANP is a method of structuring complex decisions or systems of interacting variables to enable users to define the relationships between the variables through a mathematically based process for prioritizing the components of the ANP. Variables in an ANP model typically include, for example, an overall goal; or the benefits, costs, risks and opportunities can be used as perspectives or merits to evaluate alternatives or other factors in the networks. Variables can also include lower levels of control criteria which can be organized in a single hierarchy or multiple hierarchies and can be overriding criteria based on which judgments are performed within networks. An ANP model is intended to be flexible to cover the wide variety of decisions and/or interacting variables that can be considered in business, government, education, or for private purposes. In this instance, the variables include the content category alternatives.

A decision model, such as an ANP model, can be designed to enable users to selectively participate in a structured process of prioritizing the components of a decision model using a process of comparing control criteria to one another for the importance in the decision. Further, the decision model can compare clusters of control criteria to one another for their relative importance in the decision with respect to the control criteria, and finally comparing the elements for their relative importance in the decision with respect to the clusters and control criteria.

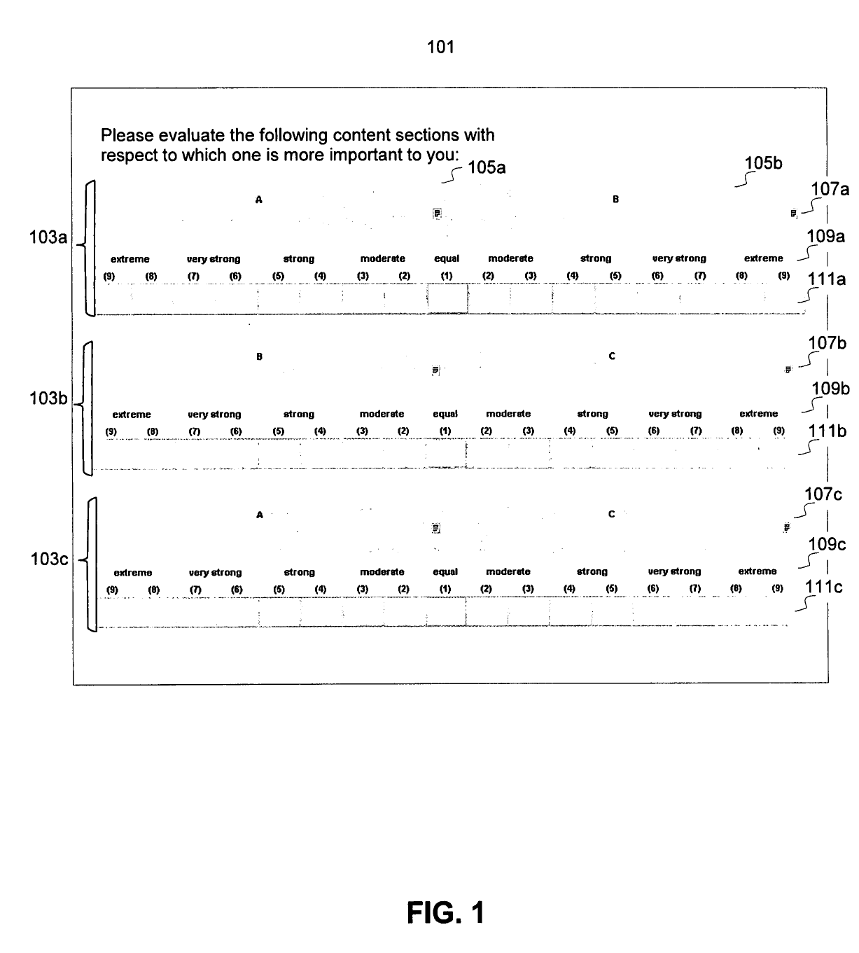

Referring now to FIG. 1, a user interface illustrating an interaction with a user to obtain pairwise comparisons for a set of content category alternatives will be discussed and described. A user interface 101 can include different content sections, which can be associated with different content category alternatives, here represented by A, B and C. It will be appreciated that, in operation, these content category alternatives can be represented by descriptors, for example, “arts”, “entertainment,” and “travel.” Also, there can be more than the three content category alternatives of this simplified illustration. The user can be prompted to perform a pairwise comparison, in this illustration, “Please evaluate the following content sections with respect to which one is more important to you.”

The illustration involves content category alternatives A, B, and C. The user can be prompted to indicate the relative importance of pairs 105a, 105b of content category alternatives. A judgment of relative importance between the pairs 105a, 105b of content category alternatives can be inputted. In the illustration, the pairwise comparisons 103a, 103b, 103c include A and B 103a, B and C 103b, and A and C 103c.

In this example, the user is requested to rate relative importance of the pair of content category alternatives on a scale of 1 to 9, between extreme, very strong, strong, moderate, and equal importance.

The number of comparisons depends on the number of content category alternatives, because a content category alternative can be compared to every other content category alternative. Pairwise comparisons need not be performed in any particular order. Also, it is not necessary for a user to input a judgment for every pairwise comparison. The judgment between preferences can be collected and input to a comparison matrix representing a respective portion of a decision model.

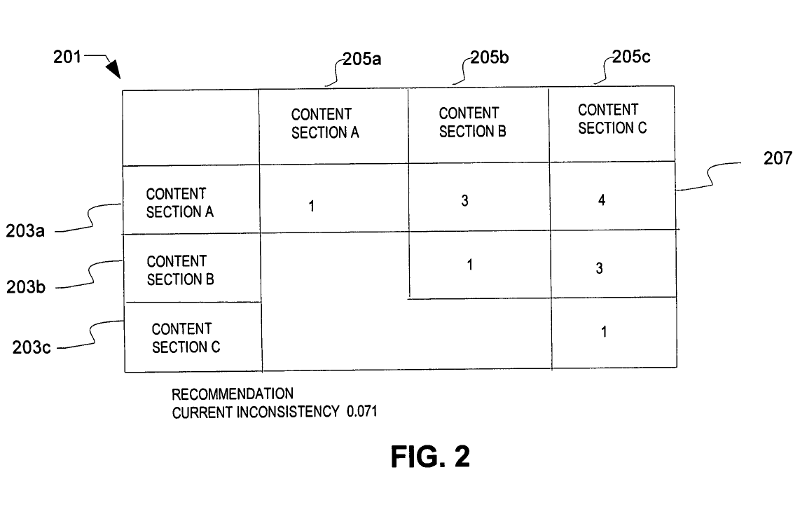

Referring now to FIG. 2, a diagram illustrating an exemplary judgment matrix 201 in accordance with one or more embodiments will be discussed and described. The judgments of a user between preferences of the content category alternatives can be conveniently stored in the matrix 201. The matrix can indicate content category alternatives as columns 205a-c and rows 203a-c. As in FIG. 1, different content category alternatives are represented by A, B and C.

The content category alternatives can be clustered (not illustrated). For example, in the cluster of news, the content category alternatives might include arts, travel, entertainment, and the like.

Other comparisons to determine relative importance can be made, for example, “with respect to news, which is more important, arts or entertainment?” “with respect to news, which is more important, arts or travel?,” and so on. Alternatively, comparisons to determine ratings can be, for example, “with respect to news, rank the following: arts, entertainment and travel,” and so on. As another alternative, a rating can be determined, for example, “with respect to news, indicate the importance rating for travel: excellent, very good, good, marginal, poor,” where excellent represents a rating of 1.0 and poor represents a rating of 0. Any number in a range can be interpolated.

Accordingly, one or more embodiments provide that the judgments are entered into a matrix, the matrix is input to the analytic hierarchy process, the weighted prioritization is output from the analytic hierarchy process, and the weighted prioritization includes a relative priority for each content category alternative.

The decision model can incorporate clusters and elements. In connection with decision models, the association of clusters and elements with descriptors, and their use, is a known technique. Also, there are many known techniques for obtaining relative importances of two or more things, which are amenable to being applied to decision models.

In one or more embodiments, it may be useful to represent the ANP model in the computer as a set of trees. For example, a matrix itself can be stored as a set of trees. However, alternative embodiments can include, for example, hierarchical databases. The matrix 201 can store priorities, such as a value 207, of the judgment of preferences between content category alternatives.

The illustrated example is a matrix 201 with respect to content sections A, B and C (illustrated in FIG. 1), sometimes referred to as “elements” in the matrix 201. Each element 203a, 203b, 203c is compared with each other element 205a, 205b, 205c.

Here, judgments have been collected on these content category alternatives from a user. Possibly, judgments have been collected from the user on only a part of the judgment matrix. For example, a user might have entered a judgment only on content section A in relation to content section B, and content section B in relation to content section C. The collected judgments can be used to calculate the values in the matrix 201.

The term “matrix” or “judgment matrix” is used to indicate a matrix for holding values of a set of elements that are to be compared to one another in relation to another element.

The priorities, e.g., values 207, of the comparisons of elements based on collected judgments can be calculated in accordance with techniques that are known, for example, geometric averages, which will not be discussed further herein to avoid obscuring the discussion. Such known techniques can be applied within the judgment matrix 201.

There can be many pairwise comparison matrices in an ANP model. A single individual can provide some or all of the judgments in a pairwise comparison matrix, or more than one individual may provide some or all of the judgments. When more than one individual provides judgments for a particular cell of a pairwise comparison matrix, the many individual judgments can be synthesized into a synthesized prioritization, for example, using a geometric mean. In a synthesized prioritization, it is possible that one individual can provide the only judgment in one cell of the matrix 201 while more than one individual can provide judgments in another cell in the same pairwise comparison matrix 201.

The judgments provided by an individual can be used to calculate a priority vector (sometimes referred to as a value or priority) for the pairwise comparison matrix. The priority vectors for all the pairwise comparison matrices of various users associated with a particular ANP model optionally can be used to populate a supermatrix corresponding to the ANP model.

The consistency of a user's judgments can be checked, in accordance with known techniques, to ensure that the set of pairwise comparisons provided by the user are consistent. If the inconsistency is above a pre-set level, for example, 10%, the user can be presented with additional judgments, to refine the user's original set of pairwise comparisons. In the illustrated matrix 201, the inconsistency is calculated to be 0.071, or 7.1%. Because the inconsistency is below the acceptable level, the user's judgments are accepted as being consistent. Inconsistency among the pairwise comparisons can be calculated in accordance with known techniques.

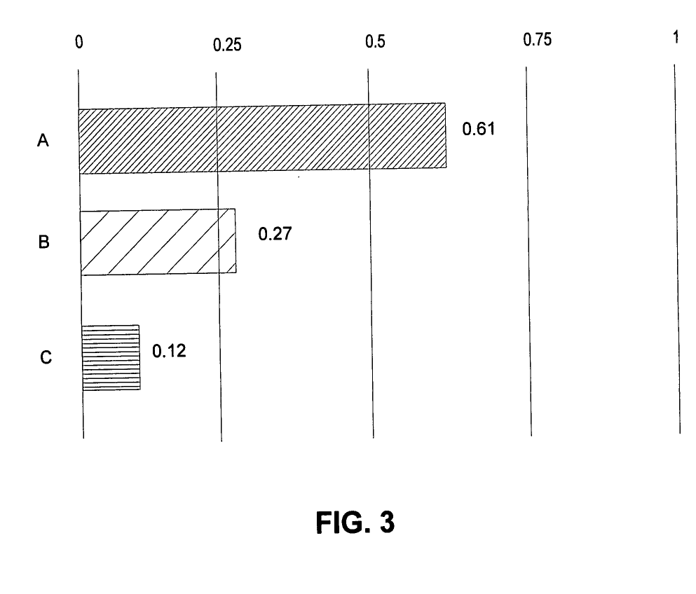

Referring now to FIG. 3, an illustration of a weighted prioritization for content category alternatives will be discussed and described. The AHP outputs a weighted prioritization for the user, where the weighted prioritization includes a relative priority for each content category alternative. In the illustrated example, the content category alternatives are represented by A, B and C. Using known AHP techniques with the matrix (illustrated in FIG. 2) as input, the relative priorities for A, B and C are, respectively, 0.61, 0.27, and 0.12.

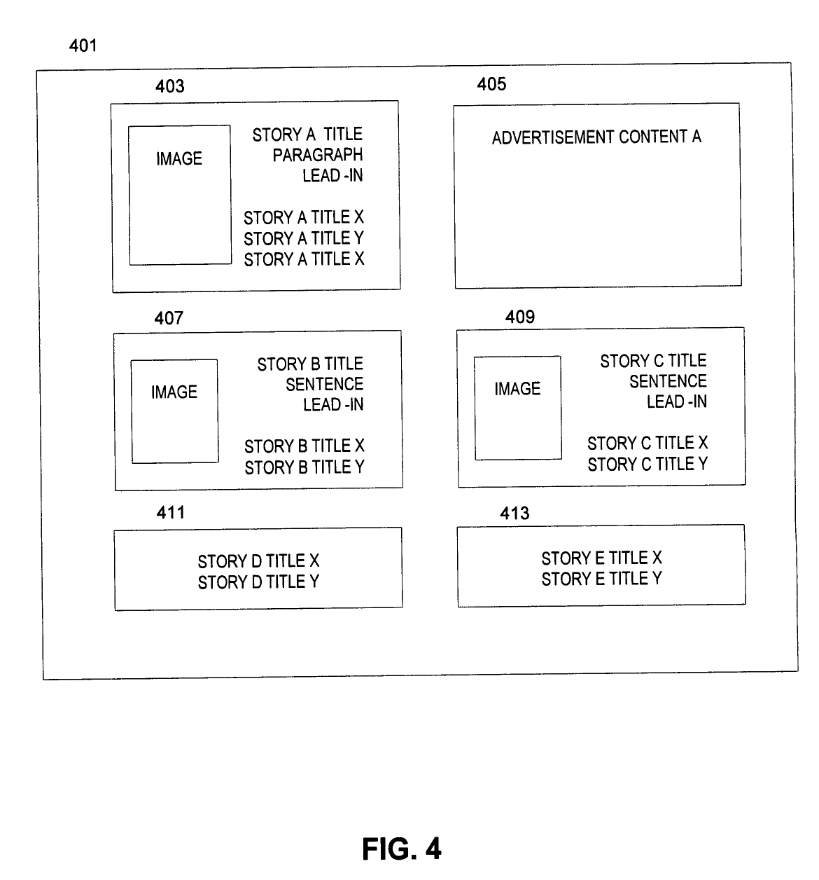

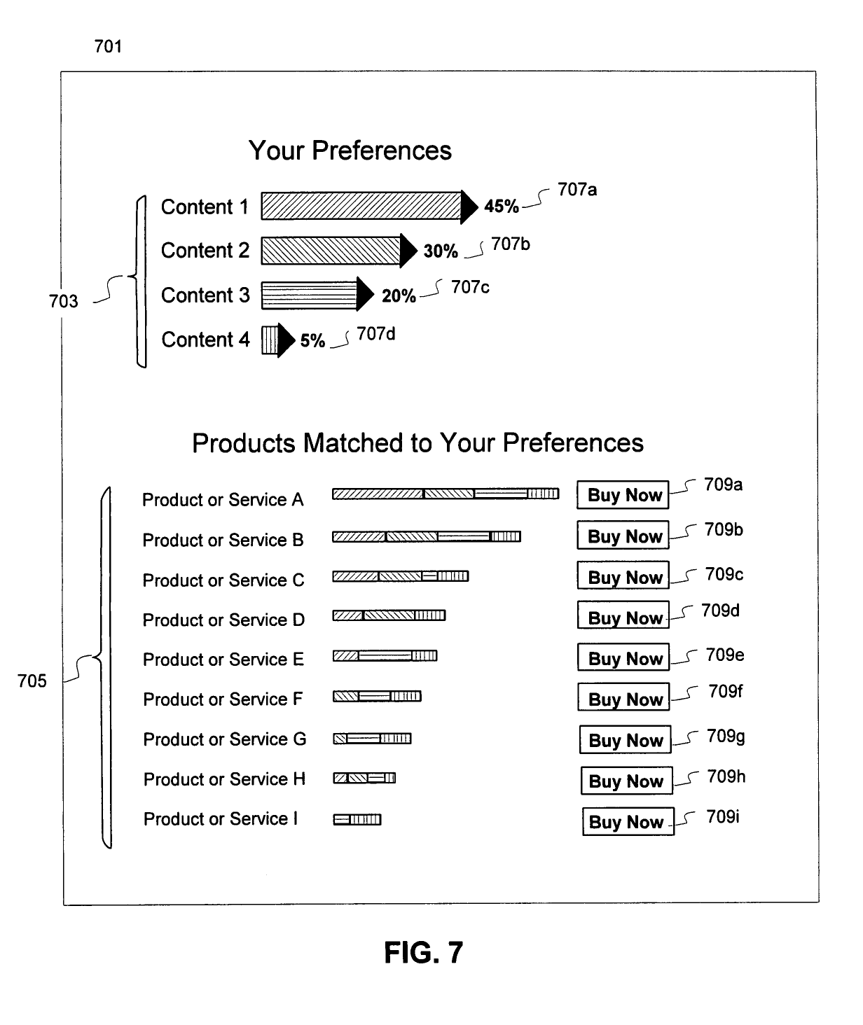

Referring now to FIG. 4, a user interface illustrating a sample layout of content will be discussed and described. Here, a layout of the content sections on a user interface 401 can be varied according to the weighted prioritization. An alternative user interface with a different layout of content is discussed in connection with FIG. 7.

The sample layout illustrated here is commonly used for news websites such as cnn.com. A highest priority section 403 is provided at a most prominent position on the page, lower priority sections 407, 409 are provided at a less prominent position on the page, and lowest priority sections 411, 413 are provided below. As is typical, the highest priority section 403 has relatively more page space, and includes a larger image, more story titles, and a larger lead-in paragraph. However, this can vary according to a web publisher's preferences. Similarly, each of the lower priority sections 407, 409, 411, 413 can have relatively lower page space, image, story titles, and lead-ins, if any. Also, in this example, space is reserved for an advertisement 405.

By use of weighted prioritizations, the prominence of each content section can be targeted to the particular user. Therefore, even in a conventional layout, the content sections can be customized to be more interesting to each particular user.

For example, the weighted prioritization of FIG. 3 have the priority (from highest to lowest) of A, B, C, where A, B and C are representative of content category alternatives such as arts, entertainment, travel, and the like. A user interface 401 can have a standardized layout with different content sections, from highest priority 403 to lowest priority 413. For this particular user, content category alternative A has the highest priority, at 0.61 (FIG. 3); therefore, the A content section is provided at the highest priority section 403. Similarly, because content category alternative B has the second highest priority, at 0.27, the B content section is provided at the second highest priority section 407. Also, because content category alternative C has the third highest priority, at 0.12, the C content section is provided at the third highest priority section 407. A different user can have different priorities for content category alternatives, so that the content will be displayed for the different user at different content sections.

Also, the user interface 401 includes one or more spaces for advertising 405. Optionally, the user interface 401 can include recommendations; an example of recommendations is discussed in connection with FIG. 7. The advertising space(s) can be assigned priority, similarly. Various advertisements are associated with different content category alternatives. For example, an advertisement for travel can be associated with a “travel” content category alternative. The content which is assigned to the advertising space 405 can be determined by priority. That is, if the advertising space 405 is assigned a highest priority, the advertisement content used in the advertising space 405 has the highest priority for the user. In this case, because content category alternative A has the highest priority (0.61), the advertising space 405 displays an advertisement associated with content category alternative A. Accordingly, one or more embodiments provides that the contents include advertisements, recommendations, and articles, wherein each advertisement, recommendation, and article is assigned one of the content category alternatives.

If a different user has a different weighted prioritization of content category alternatives, the content sections will be laid out differently. Therefore, the display can be targeted to a particular user's preferences.

Accordingly, one or more embodiments provides a method, implemented on a computer, a device, and/or a system for targeting contents according to preferences of a particular user, wherein a content is associated with ones of plural content category alternatives, wherein the content is different from other contents. This includes inputting, into a computer, a plurality of pairwise comparisons for a particular user for a set of content category alternatives, wherein a pairwise comparison includes a judgment between preferences as a relative importance between two content category alternatives. Also included is preparing, in the computer, a weighted prioritization of the content category alternatives of the pairwise comparisons for the particular user, according to an analytic hierarchy process. Also included is applying, in the computer, the weighted prioritization of the content category alternatives for the particular user to the contents, associating a weight with the content according to the weighted prioritizations of the content category alternative corresponding to the content categorization of the contents, and providing the contents according to the weight.

Furthermore, one or more embodiments provides that the contents are to be provided on a display, the display is divided into content sections in which the contents are to be provided, each content section is associated with one of the plural content category alternatives, and placement of respective content sections on the display depends on the weighted prioritizations for respective content category alternatives.

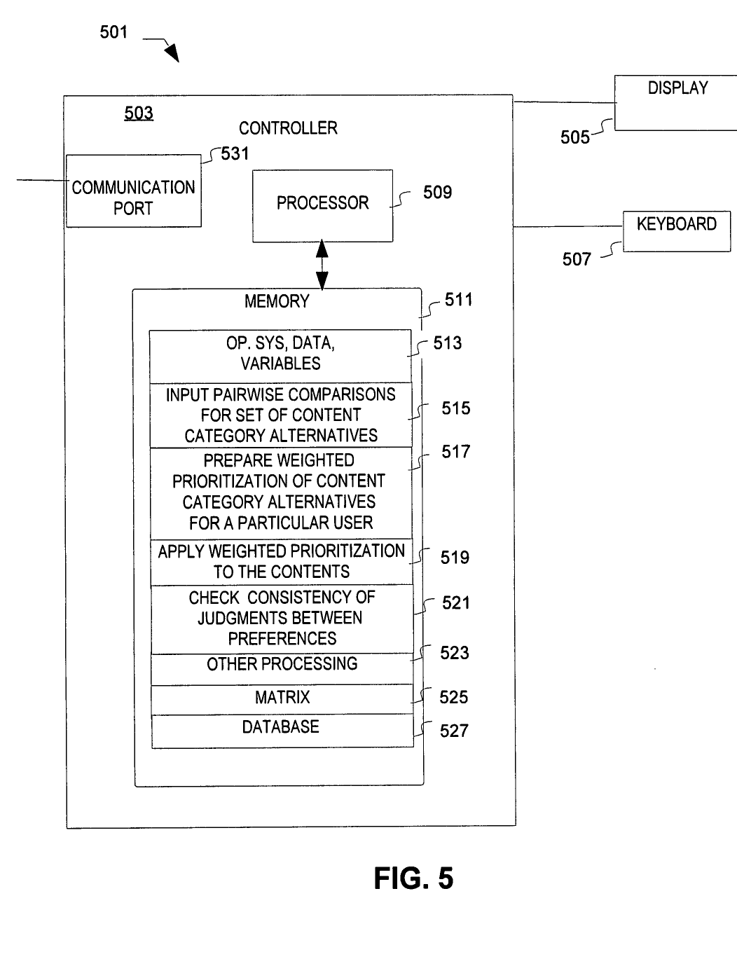

Referring now to FIG. 5, a block diagram illustrating portions of an exemplary computer in accordance with various embodiments will be discussed and described. The computer 501, such as a computer-implemented device, may include one or more controllers 503. The controller 503 can be operably connected to a communication port 531 for sending and receiving transmissions on a network, a text and/or image display 505, and/or a user input device such as a keyboard 507. The controller 503 can also include a processor 509 and one or more memories 511.

The processor 509 may comprise one or more microprocessors and/or one or more digital signal processors. The memory 511 may be coupled to the processor 509 and may comprise a read-only memory (ROM), a random-access memory (RAM), a programmable ROM (PROM), and/or an electrically erasable read-only memory (EEPROM). The memory 511 may include multiple memory locations for storing, among other things, an operating system, data and variables 513 for programs executed by the processor 509; computer programs for causing the processor to operate in connection with various functions such as inputting pairwise comparisons for a set of content category alternatives 515, preparing a weighted prioritization of content category alternatives for a particular user 517, applying weighted prioritization to the contents 519, checking the consistency of judgments between preferences 521, and other optional processing 523; a database of information used in connection with the decision model such as a matrix 525; and a database 527 of other information used by the processor 509. The computer programs may be stored, for example, in ROM or PROM and may direct the processor 509 in controlling the operation of the computer 501.

The processor 509 may be programmed for inputting pairwise comparisons for a set of content category alternatives 515. This can be performed, for example by interacting with a user via, e.g., the display 505 and keyboard 507, or by receiving data. The user can input fewer than all of the possible pairwise comparisons, if preferred. The pairwise comparisons are associated with the particular user, so that the targeting of contents can be directed to the particular user. For example, the pairwise comparisons can be associated with a unique user identifier.

The processor 509 can be programmed for preparing a weighted prioritization of content category alternatives for a particular user 517. A decision model, for example an AHP, or more particularly an ANP can be used to calculate the weighted prioritization of the content category alternatives for the particular user. The use of a decision model to calculate weighted prioritization is a known technique. Accordingly, for a particular user, each content category alternative can be assigned a relative priority.

The processor 509 can be programmed for applying weighted prioritization to the contents 519. Each of the contents which can be provided to the user can be assigned to one or more content category alternatives, for example by the provider of the content. The weighted prioritization of the content category alternatives for the particular user is applied to a selection of the contents. Each of the contents in the selection is assigned a weight according to the user's weighted prioritization for the content's corresponding content category alternative(s). The contents then can be provided according to the weight. For example, if a particular content is assigned content category alternative A, and if the weighted prioritization for a particular user for content category A is a highest priority weight, then the particular content is provided at a highest priority.

The processor 509 can be programmed for checking the consistency of judgments between preferences 521. This has been previously described in detail. Accordingly, one or more embodiments provides for checking a consistency of judgments between the preferences for the particular user according to the analytic hierarchy process, and if the preferences are inconsistent, further interacting with the user to refine inconsistencies in the preferences for the particular user.

The processor 509 can be programmed for other optional processing 523. For example, the other processing can include an interface with an advertising engine, a content display engine, content management system, a recommendation engine, and/or the like. The weighted prioritizations of the content category alternatives can be provided as input to the advertising engine (or similar), so that the advertising engine can appropriately target the advertisements, contents, and/or recommendations.

The memory 511 provided in association with the processor 509 can store data in the database 527 for the information used in connection with the decision model, for example, an ANP model. The decision model, or portions thereof, can be located in the memory 51 1. Alternatively, the database 527 can provide access to the decision model, for storing and/or retrieving information from the decision model, where the decision model is stored locally or remotely for access.

Optionally, other components may be incorporated in the computer 501 to produce other actions. For example, a user can interface with the computer 501, via a known user interface such as OUTLOOK, WINDOWS, and/or other commercially available interfaces. Further, the computer 501 can send and receive transmissions via known networking applications operating with the communication port 531 connected to a network, for example, a local area network, intranet, or the Internet and support software.

It should be understood that various embodiments are described herein in connection with logical groupings of programming of functions. One or more embodiments may omit one or more of these logical groupings. Likewise, in one or more embodiments, functions may be grouped differently, combined, or augmented. For example, in one or more embodiments, inputting the pairwise comparisons can be done over time; and/or preparing the weighted prioritization can be done separately from applying the weighted prioritization to the contents. In addition, some of these functions may be performed predominantly or entirely on one or more remote computers (not illustrated); and therefore such functions can be reduced or omitted from the processor 509 and distributed to the remote computer. Similarly, the present description may describe various databases or collections of data and information. One or more embodiments can provide that databases or collections of data and information can be distributed, combined, or augmented, or provided locally (as illustrated) and/or remotely (not illustrated).

The user may invoke functions accessible through the keyboard 507. As alternatives to the keyboard 507, or in addition to the keyboard 507, one or more other various known input devices can be provided, such as a keypad, a computer mouse, a touchpad, a touch screen, a trackball, remote input device, and/or a pointing device. The keyboard is optional for one or more embodiments.

The computer 501 can include or be connected to the text and/or image display 505, upon which information may be displayed. The display is optional for one or more embodiments. The display 505 may present information to the user by way of a conventional liquid crystal display (LCD) or other visual display, and/or by way of a conventional audible device (such as a speaker, not illustrated) for playing out audible information.

The computer 501 can include one or more of the following, not illustrated: a floppy disk drive, a hard disk drive (not shown), and a CD ROM or digital video/versatile disk, at internal or external hard drives. The number and type of drives can vary, as is typical with different configurations, and may be omitted. Instructions for operating the processor 509 can be provided electronically, for example, from the drive, via the communication port 531, or via the memory 511.

Accordingly, one or more embodiments provide a computer-implemented system for targeting contents according to preferences of a particular user using an analytic hierarchy process, wherein a content is associated with ones of plural content category alternatives, wherein the content is different from other contents. The system can include a display, an input device, and a computer processor, where the computer processor is specially configured as discussed herein.

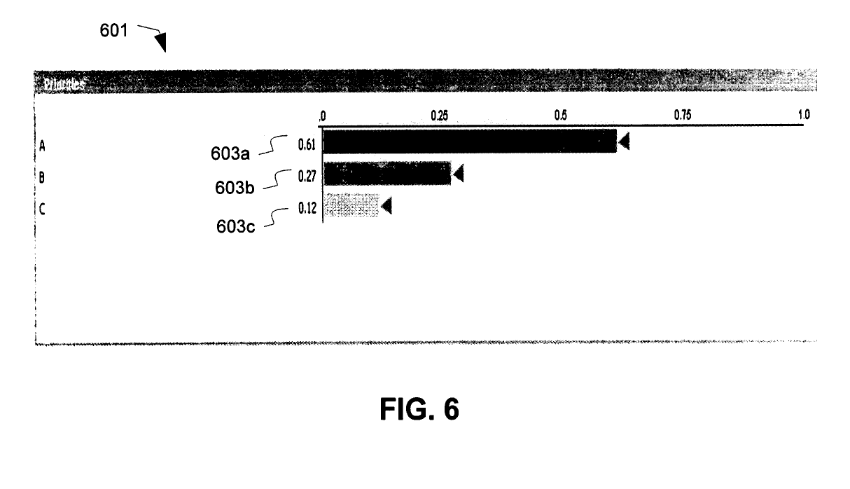

Referring now to FIG. 6, an illustration of a user interface illustrating an interaction with the user to change priority will be discussed and described. This interaction illustrates a user interface 601 which provides a sensitivity analysis. The sensitivity analysis can enable users to change their preferences over time.

In this user interface 601, the sensitivity analysis includes relative preferences for the content category alternatives A, B, C as represented by bar graphs 603a, 603b, 603c. The user can change the relative preferences of one of the bar graphs 603a, 603b, 603c, and the weighted prioritization of the other content category alternatives can be re-calculated and revised. Then, the content management system can revise the layout of the web page according to the revised weighted prioritization. The sensitivity analysis can be incorporated into a web page which displays the contents, for example as illustrated in FIG. 7.

Alternatively, the sensitivity analysis can include relative preferences represented by other types of graphs, dials, buttons, or similar.

Accordingly, one or more embodiments provides for, after preparing the weighted prioritization, interacting with the user to change a subset of the plurality of pairwise comparisons, and then automatically updating the weighted prioritization of the content category alternatives for the particular user, and adjusting the weight of the contents to the weight according to the updated weighted prioritization.

Referring now to FIG. 7, an example user interface 701 illustrating a product or service recommendation will be discussed and described. Here, a sensitivity analysis 703 for relative preferences is provided for the content category alternatives are content 1, content 2, content 3, and content 4 707a-d. A listing 705 of various products or services matched to the user's preferences are also provided in the user interface 701. The listing 705 can also include a visual indication of the content category alternatives assigned to each content, such as the illustrated bar graph for each product or service which is recommended. Optionally, the listing 705 can include a button 709a-i so that the user can immediately select one or more listed products or services. In this example, a content can be assigned multiple content category alternatives, and each can be assigned a weight for the content. Hence, “product or service I” is assigned both “content 3” and “content 4”, at different weights.

As a more concrete example of FIG. 7, consider that a user is looking for movie recommendations, and that content 1, 2, 3, and 4 are representative of the content category alternatives which are movie genres, such as romance, drama, comedy, and horror, respectively. This particular user has weighted prioritizations of the content category alternatives (romance, drama, comedy, and horror), respectively, at 45%, 30%, 20%, and 5%. Similarly, a product or service is representative of a movie title, e.g., “product or service A” is representative of “Dreamgirls”, “product or service B” is representative of “Music and Lyrics”, “product or service C” is representative of “Curse of the Golden Flower,” and so on. Note that “product or service A” (e.g., “Dreamgirls”) is assigned to contents 1, 2, 3 and 4 (comedy, drama, romance, and horror), and that each of the content category alternatives has a different weight assigned to this particular content. Because “product or service A” (e.g., “Dreamgirls”) has a weighting of content category alternatives which most closely matches the user's particular weighted prioritizations, “product or service A” can be listed first. “Product or service B” is the second weight because it has a weighting of content category alternatives which is the second closest match to the user's particular weighted prioritizations. “Product or service I” is the last of the content, because it is the most distance match to the user's particular weighted prioritizations. Any appropriate statistical calculation can be used to determine how close a content's weighted prioritization and a user's weighted prioritization are.

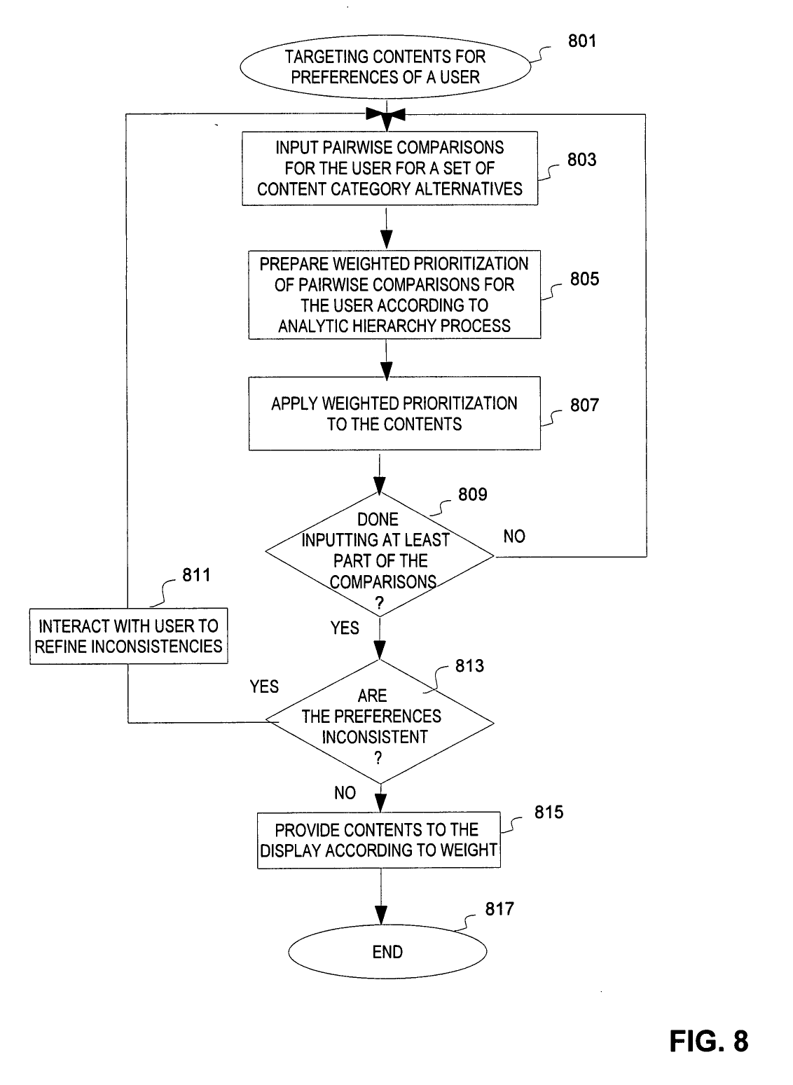

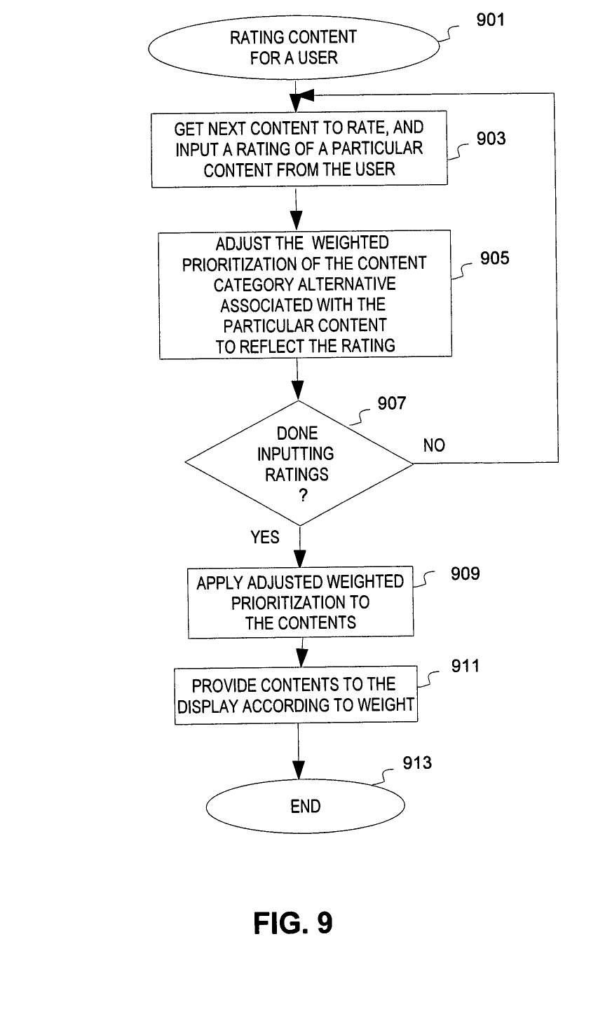

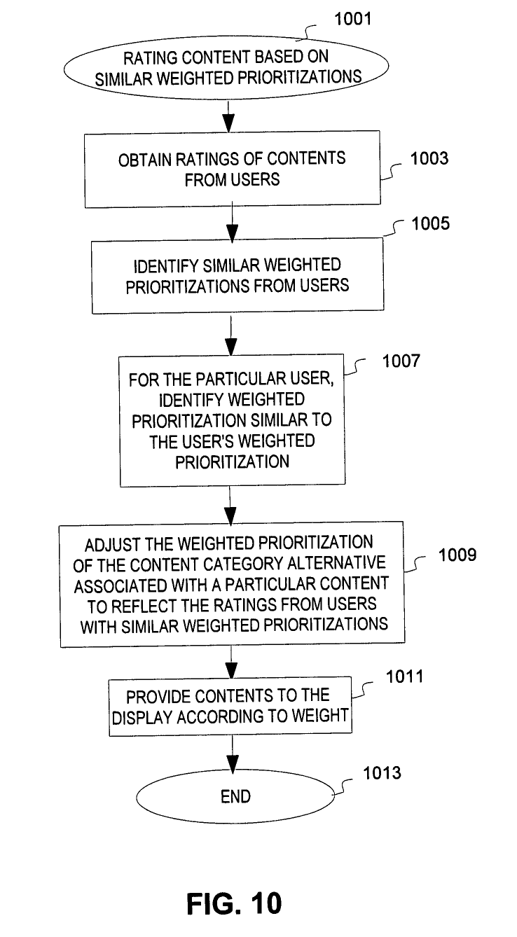

FIG. 8, FIG. 9, and FIG. 9 provide flow charts illustrating procedures which can implement targeting contents according to preferences of a particular user. FIG. 8 provides an overall flow chart for the user inputting preferences through providing a targeted display. FIG. 9 and FIG. 10 illustrate options incorporating the use of user ratings; in FIG. 9, the individual user rates the content which is used to adjust the user's weighted prioritization; and in FIG. 10, groups of users have rated content, and contents are provided to a particular user based on the other users with similar weighted prioritizations. The procedures can advantageously be implemented on, for example, a processor of a controller, described in connection with FIG. 5 or other apparatus appropriately arranged.

Referring now to FIG. 8, a flow chart illustrating an exemplary procedure 801 for targeting contents for preferences of a user, in accordance with various exemplary and alternative exemplary embodiments will be discussed and described. The example procedure 801 includes inputting 803 pairwise comparisons for the user for a set of content category alternatives.

Then, for each of the input pairwise comparisons, the example procedure prepares 805 a weighted prioritization of the pairwise comparisons for the user according to an analytic hierarchy process (AHP). Then, the procedure applies 807 the weighted prioritization to the contents which are to be provided to the user. If the user is not done 809 inputting at least part of the comparisons, then the procedure 801 loops to input additional pairwise comparisons.

If the user is done inputting pairwise comparisons, then the procedure 801 checks 813 whether the preferences are inconsistent. Checking for inconsistency was previously described. If the preferences are inconsistent, then the procedure 801 interacts 811 with the user to refine the inconsistencies among the pairwise comparisons. In this example procedure, the pairwise comparisons are refined by prompting the user to re-input 803 the pairwise comparisons.

Once the preferences are input and consistent, and the weighted prioritization is applied to the contents, the contents are provided 815, for example to the user's display according to the respective weight for individual items in the content. Then, the procedure can end 817.

Referring now to FIG. 9, a flow chart illustrating an exemplary procedure 901 for rating content for a user will be discussed and described. In this example procedure 901, the individual user rates the content, and the rating of the content is used to adjust the user's weighted prioritization. Content can be presented to the user to be rated. Presumably the user will favorably rate content which most closely matches the user's weighted prioritization.

This example procedure 901 interacts with the user to input 903 a rating of a particular content from the user. In this case, a “rating” refers to an evaluation of a particular content, and can be, for example, an indication of how the particular user categorizes the particular content, or if the particular user agrees with the content category alternatives assigned to the particular content, or if the particular user likes/dislikes the particular content, and similar variations and modifications. Then, the procedure adjusts 905 the user's weighted prioritization of the content category alternative(s) associated with the particular content to reflect the rating. The procedure 901 loops if not done 907 inputting ratings.

When the procedure is done inputting ratings, it applies 909 the adjusted weighted prioritization to the contents. The contents can then be provided 911 to the display according to the weight. Then, the procedure can end 913.

Accordingly, one or more embodiments provides for inputting a rating of a particular content for the particular user, and adjusting a weighted prioritization of the content category alternative associated with the particular content.

Referring now to FIG. 10, a flow chart illustrating an exemplary procedure 1001 for rating content based on similar weighted prioritizations will be discussed and described. In this procedure 1001, groups of users have provided ratings of content. Content can be provided to a user by using ratings from other users which have similar weighted prioritizations.

The procedure 1001 includes obtaining 1003 ratings of contents from various users. For example, users can be prompted to provide ratings of various contents, and a history of ratings can be stored together with an indication of the user which made that rating. The history of ratings can be obtained over a period of time.

Then, the procedure 1001 can include identifying 1005 similar weighted prioritizations from users. To identify similar weighted prioritizations, the weighted prioritizations can be stored in a storage (e.g., a database). The storage of weighted prioritizations can be searched to identify weighted prioritizations which are sufficiently similar. Similarity can be based on, for example, similarity of distribution of weights for content category alternatives within a selected error factor. Weighted prioritizations which are similar optionally can be linked together.

For a particular user, the procedure can identify 1007 weighted prioritizations which are similar to the user's weighted prioritization. For example, if a particular user is to be provided with a recommendation based on similar users, the identifying 1007 can include determining the weighted prioritization for the particular user and searching a storage (e.g., database) of weighted prioritizations for other weighted prioritizations which are sufficiently similar.

Then, the procedure 1001 can target content to the user based on similar weighted prioritizations. The example procedure adjusts 1009 the user's weighted prioritization of the content category alternative(s) associated with the particular content to reflect the ratings from users with similar weighted prioritizations.

Finally, the contents can be provided 1011 to the particular user according to the adjusted weight, including applying the adjusted weighted prioritization to the contents. Then, the procedure can end 1013.

Similar weighted prioritizations can be used in variations on the above. For example, targeting of contents can be based on ratings from users with similar weighted prioritizations; it can be assumed by the procedure that a particular user will rate a particular content the same as other users with similar weighted prioritizations.

Accordingly, one or more embodiments provide for inputting ratings of particular contents from plural users, and identifying similar weighted prioritizations from plural users, wherein the weight assigned to the particular contents for the particular user is further based on the ratings among weighted prioritizations which are similar to the weighted prioritization for the particular user.

The term “content” is used herein to indicate a unitary, stand-alone item of content which is intended to be presented to the user. Examples of a content include an advertisement, a recommendation, or an article. An advertisement can be a notice, a poster or an announcement in the print, broadcast, or electronic media, designed to attract public attention or patronage. A recommendation can be, for example, an indication of an item for the purchase, a rental item, a person, a product or service offered by an entity, or similar. An article can include text and/or images forming an independent part of a publication, and optionally can be further subdivided into title, summary, and the like. As used herein, the designation “content” indicates singular, and the designation “contents” indicates plural.

The term “content category alternative” is used herein to refer to different categories to which content can be assigned. The categories can be mutually exclusive. A “set of content category alternatives” refers to the logical group of content category alternatives. Content category alternatives and sets can be assigned descriptors as desired and may include, by way of example and not limitation, movie genres (drama, horror, romance, comedy, etc.); music categories (jazz, rock, classic, etc.); news types (local, national, legal, entertainment, etc.); market segmentation (teens, young singles, college students, boomers, etc.); and the like. A content can be assigned one or more content category alternatives. Where a content is assigned to multiple content category alternatives, the content category alternatives optionally can be weighted, e.g., a movie can be assigned as romance and comedy, or the movie can be assigned as 0.75 romance and 0.25 comedy.

The designation “pairwise comparison” is used herein to indicate a process of comparing content category alternatives in pairs to judge which of each pair is preferred, or has a greater amount of some quantitative property, as well as the strength of the preference between the content category alternatives.

The term “weighted prioritization” is used to refer to weights which are associated with respective content category alternatives, so that content category alternatives are weighed relative to each other. The weights can be determined in accordance with known techniques, for example, by an analytic hierarchy process using inputs from a pairwise comparison of the content category alternatives. Weights typically represent a percentage reflecting the preference, where a higher percentage indicates that the content category alternative is more preferred. However, other implementations are possible. A weighted prioritization can be associated with a particular user.

The above is sometimes described in terms of a single user, for ease of understanding and illustration. However, it is understood that multiple users are intended to be accommodated. For example, multiple users each can be associated with their own pairwise comparisons and weighted prioritization.

The foregoing description suggests that one or more embodiments include a communications capability. Devices providing communications capability can include those providing or facilitating voice communications services or data or messaging services over cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof. Moreover, the communications capability that may be utilized in connection with one or more embodiments can include, for example, short range wireless communications capability normally referred to as WLAN (wireless local area network) capabilities, using CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System), and/or other protocol structures. Alternatively communications may be provided in a wireline and/or wireless environment, for example, in accordance with a LAN using protocols such as TCP/IP, UDP/UP, IPX/SPX, or Net BIOS via a hardwired interface such as a cable and/or a connector or wireless interface. Moreover, communications may be provided by variations, extensions, evolutions, and/or combinations of such communications capabilities.

Furthermore, the devices of interest may include, without being exhaustive, general purpose computers, specially programmed special purpose computers, personal computers, distributed computer systems, calculators, handheld computers, keypads, laptop/notebook computers, mini computers, mainframes, super computers, personal digital assistants, communication devices, as well as networked combinations of the same, and the like, although other examples are possible as will be appreciated by one of skill in the art.

One or more embodiments may rely on the integration of various components including, as appropriate and/or if desired, hardware and software servers, database engines, and/or other content providers. One or more embodiments may be connected over a network, for example the Internet, an intranet, or even on a single computer system. Moreover, portions can be distributed over one or more computers, and some functions may be distributed to other hardware, in accordance with one or more embodiments.

Further, portions of various embodiments can be provided in any appropriate electronic format, including, for example, provided over a communication line as electronic signals, provided on floppy disk, provided on CD ROM, provided on optical disk memory, etc.

Any presently available or future developed computer software language and/or hardware components can be employed in various embodiments. For example, at least some of the functionality discussed above could be implemented using Visual Basic, C, C++, Java or any assembly language appropriate in view of the processor being used.

One or more embodiments may include a process and/or steps. Where steps are indicated, they may be performed in any order, unless expressly and necessarily limited to a particular order. Steps that are not so limited may be performed in any order.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method, implemented on a computer, for targeting contents according to preferences of a particular user, wherein a content is associated with ones of plural content category alternatives, wherein the content is different from other contents, comprising:
(A) inputting, into a computer, a plurality of pairwise comparisons for a particular user for a set of content category alternatives, wherein a pairwise comparison includes a judgment between preferences as a relative importance between two content category alternatives;
(B) preparing, in the computer, a weighted prioritization of the content category alternatives of the pairwise comparisons for the particular user, according to an analytic hierarchy process; and
(C) applying, in the computer, the weighted prioritization of the content category alternatives for the particular user to the contents, associating a weight with the content according to the weighted prioritizations of the content category alternative corresponding to the content categorization of the contents, and providing the contents according to the weight.

2. The method of claim 1,
wherein the judgments are entered into a matrix,
wherein the matrix is input to the analytic hierarchy process,
wherein the weighted prioritization is output from the analytic hierarchy process,
wherein the weighted prioritization includes a relative priority for each content category alternative.

3. The method of claim 1, further comprising
checking a consistency of judgments between the preferences for the particular user according to the analytic hierarchy process, and
if the preferences are inconsistent, further interacting with the user to refine inconsistencies in the preferences for the particular user.

4. The method of claim 1,
wherein the contents include advertisements, recommendations, and articles,
wherein each advertisement, recommendation, and article is assigned one of the content category alternatives.

5. The method of claim 1,
wherein the contents are to be provided on a display,
wherein the display is divided into content sections in which the contents are to be provided,
wherein each content section is associated with one of the plural content category alternatives,
wherein placement of respective content sections on the display depends on the weighted prioritizations for respective content category alternatives.

6. The method of claim 1, further comprising
inputting a rating of a particular content for the particular user, and
adjusting a weighted prioritization of the content category alternative associated with the particular content.

7. The method of claim 1, further comprising
inputting ratings of particular contents from plural users, and
identifying similar weighted prioritizations from plural users,
wherein the weight assigned to the particular contents for the particular user is further based on the ratings among weighted prioritizations which are similar to the weighted prioritization for the particular user.

8. The method of claim 1, further comprising, after preparing the weighted prioritization, interacting with the user to change a subset of the plurality of pairwise comparisons, and then
automatically updating the weighted prioritization of the content category alternatives for the particular user, and adjusting the weight of the contents to the weight according to the updated weighted prioritization.

9. A computer-readable medium comprising instructions for execution by a computer, the instructions including a computer-implemented method for targeting contents according to preferences of a particular user, wherein a content is associated with ones of plural content category alternatives, wherein the content is different from other contents, the instructions for implementing the steps of:
(A) inputting a plurality of pairwise comparisons for a particular user for a set of content category alternatives, wherein a pairwise comparison includes a judgment between preferences as a relative importance between two content category alternatives;
(B) preparing a weighted prioritization of the content category alternatives of the pairwise comparisons for the particular user, according to an analytic hierarchy process; and
(C) applying the weighted prioritization of the content category alternatives for the particular user to the contents, associating a weight with the content according to the weighted prioritizations of the content category alternative corresponding to the content categorization of the contents, and providing the contents according to the weight.

10. The computer-readable medium of claim 9,
wherein the judgments are entered into a matrix,
wherein the matrix is input to the analytic hierarchy process,
wherein the weighted prioritization is output from the analytic hierarchy process,
wherein the weighted prioritization includes a relative priority for each content category alternative.

11. The computer-readable medium of claim 9, further comprising instructions for
checking a consistency of judgments between the preferences for the particular user according to the analytic hierarchy process, and
if the preferences are inconsistent, further interacting with the user to refine inconsistencies in the preferences for the particular user.

12. The computer-readable medium of claim 9,
wherein the contents include advertisements, recommendations, and articles,
wherein each advertisement, recommendation, and article is assigned one of the content category alternatives.

13. The computer-readable medium of claim 9,
wherein the contents are to be provided on a display,
wherein the display is divided into content sections in which the contents are to be provided,
wherein each content section is associated with one of the plural content category alternatives,
wherein placement of respective content sections on the display depends on the weighted prioritizations for respective content category alternatives.

14. The computer-readable medium of claim 9, further comprising instructions for
inputting a rating of a particular content for the particular user, and
adjusting a weighted prioritization of the content category alternative associated with the particular content.

15. The computer-readable medium of claim 9, further comprising instructions for
inputting ratings of particular contents from plural users, and
identifying similar weighted prioritizations from plural users,
wherein the weight which the particular contents is assigned for the particular user is further based on the ratings among weighted prioritizations which are similar to the weighted prioritization for the particular user.

16. A computer-implemented system for targeting contents according to preferences of a particular user using an analytic hierarchy process, wherein a content is associated with ones of plural content category alternatives, wherein the content is different from other contents, comprising:
(A) a display,
(B) an input device,
(C) a computer processor, in communication with the display and the input device, the computer processor being configured to facilitate
(1) inputting, from the input device, a plurality of pairwise comparisons for a particular user for a set of content category alternatives, wherein a pairwise comparison includes a judgment between preferences as a relative importance between two content category alternatives;
(2) preparing a weighted prioritization of the content category alternatives of the pairwise comparisons for the particular user, according to an analytic hierarchy process;
(3) applying the weighted prioritization of the content category alternatives for the particular user to the contents, associating a weight with the content according to the weighted prioritizations of the content category alternative corresponding to the content categorization of the contents, and
(4) providing the contents to the display according to the weight,
wherein the computer processor is further configured to enter the judgments into a matrix,
wherein the matrix is input to the analytic hierarchy process,
wherein the weighted prioritization is output from the analytic hierarchy process,
wherein the weighted prioritization includes a relative priority for each content category alternative.

17. The computer-implemented system of claim 16, wherein the computer processor is further configured for
checking a consistency of judgments between the preferences for the particular user according to the analytic hierarchy process, and
if the preferences are inconsistent, further interacting with the user to refine inconsistencies in the preferences for the particular user.

18. The computer-implemented system of claim 16,
wherein the display is divided into content sections in which the contents are to be provided,
wherein each content section is associated with one of the plural content category alternatives,
wherein placement of respective content sections on the display depends on the weighted prioritizations for respective content category alternatives.

19. The computer-implemented system of claim 16, wherein the computer processor is further configured for
inputting a rating of a particular content for the particular user, and
adjusting a weighted prioritization of the content category alternative associated with the particular content.

20. The computer-implemented system of claim 16, wherein the computer processor is further configured for inputting ratings of particular contents from plural users, and identifying similar weighted prioritizations from plural users,
wherein the weight which the particular contents is assigned for the particular user is further based on the ratings among weighted prioritizations which are similar to the weighted prioritization for the particular user.
